(19) United States
(12) Patent Application Publication
(10) Pub. No.: US 2010/0045238 A1
(43) Pub. Date: Feb. 25, 2010

(54) Battery Detecting System

(76) Inventors: Tzi-Yu JAU, Rueifang Township (TW); Song-Hong Shieh, Tainan City (TW)

Correspondence Address: THE LAW OFFICES OF ANDREW D. FORTNEY, PH.D., P.C., 215 W FALLBROOK AVE SUITE 203, FRESNO, CA, 93711, US

(21) Appl. No.: 12/607,022

(22) Filed: Oct. 27, 2009

Related U.S. Application Data
(63) Continuation of application No. 11/262,033, filed on Oct. 27, 2005, now abandoned.

(30) Foreign Application Priority Data
Nov. 3, 2004 (TW) 093133430

(51) Int. Cl. H02J 7/00; H02J 7/16; G08B 21/00

(52) U.S. Cl. 320/128; 320/165; 340/636.1

(57) ABSTRACT

The invention discloses a detecting system for detecting whether a battery is connected to an electronic apparatus. The battery has a thermic resistor. The detecting system includes a power supply, a detecting resistor, and a detecting unit. The power supply generates a testing current. The detecting resistor is connected to the power supply and the thermic resistor. The detecting circuit is connected to a node between the detecting resistor and the thermic resistor. The detecting circuit detects a first voltage of the node and generates a detecting signal to determine whether the battery is electrically connected to the electronic apparatus.

### RELATED APPLICATIONS

This application is a continuation of U.S. patent application Ser. No. 11/262,033, filed Oct. 27, 2005 (Attorney Docket No. 5MTK200406US), which claims priority to Taiwan Application No. 093133430 filed Nov. 3, 2004, each of which is incorporated herein by reference in its entirety.

### BACKGROUND OF THE INVENTION

1. Field of the Invention

The invention relates to a detecting system, and more particularly to a detecting system for detecting whether a battery is connected to an electronic apparatus.

2. Description of the Prior Art

Conventional batteries of mobile phones are usually classified into the following two types: those having three metal pins and those having four metal pins. For batteries with three metal pins, the three metal pins are respectively used for reflecting inner voltage, temperature, and current. The fourth metal pin is used for determining what kind the battery is, such as a Nickel-Metal Hydride battery or a Lithium battery. Currently, considering the practicability, the Nickel-Metal Hydride battery has been gradually eliminated through competition. Thus, fewer and fewer batteries with four metal pins are used in today's market. Accordingly, the battery having three metal pins is more popular at present.

A thermic resistor is usually equipped within a battery in a mobile phone for indicating present temperature of the battery. Although such battery is capable of indicating conditions including inner voltage, temperature, and current, there is no metal pin for detecting whether the battery is connected to the mobile phone. Accordingly, problems occur when the mobile phone is operated. For example, when a user is charging the mobile phone but the battery is not in the mobile phone or not connected to the mobile phone well due to an external force, the mobile phone may be damaged due to improper charging.

Therefore, it is beneficial to provide a detecting system to solve the above-mentioned problem.

### SUMMARY OF THE INVENTION

An objective of the invention is to provide a detecting system for detecting whether a battery is electrically connected to an electronic apparatus.

One embodiment according to the invention discloses a detecting system for detecting whether a battery is electrically connected to an electronic apparatus. The battery has a thermic resistor. The detecting system includes a power supply, a detecting resistor, and a detecting circuit. The power supply is used for generating a testing current. The detecting resistor is connected to the power supply and the thermic resistor. The detecting circuit is connected to a node between the detecting resistor and the thermic resistor. The detecting circuit is used for detecting a first voltage of the node and for generating a detecting signal to indicate whether the battery is electrically connected to the electronic apparatus.

Because the thermic resistor of the battery varies with the temperature of the battery and the voltage between two ends of the thermic resistor varies in response to the temperature, the detecting system of the invention utilizes the detecting circuit to detect the voltage of the node, and then compares the detected voltage with a predetermined reference voltage to detect whether the battery is electrically connected to the electronic apparatus.

With the following description as well as accompanied drawings, it is more clear to understand advantage and spirit of the invention.

### BRIEF DESCRIPTION OF THE APPENDED DRAWINGS

FIG. 1 is a system block diagram illustrating a detecting system according to a preferred embodiment of the invention.

FIG. 2 is a schematic diagram illustrating the relation between the thermic resistor and the temperature of the battery.

FIG. 3 is a schematic diagram illustrating the relation between the voltage and the temperature.

FIG. 4 is a schematic diagram illustrating the detecting system according to another preferred embodiment of the invention.

FIG. 5 is a schematic diagram illustrating the detecting system according to another embodiment of the invention.

FIG. 6 is a schematic diagram illustrating the detecting system according to another embodiment of the invention.

FIG. 7 is a flowchart illustrating the detecting method according to a preferred embodiment of the invention.

### DETAILED DESCRIPTION OF THE INVENTION

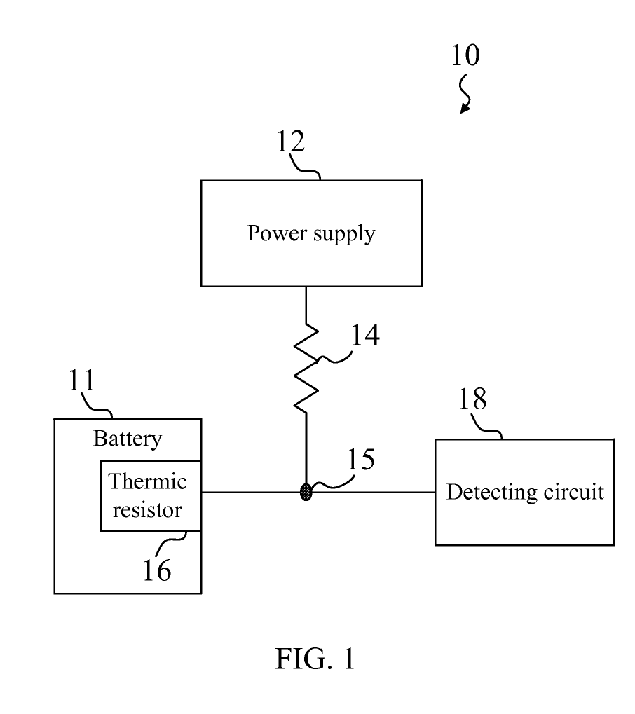

FIG. 1 is a system block diagram illustrating a detecting system 10 according to a preferred embodiment of the invention. The embodiment discloses a detecting system 10 for detecting whether a battery 11 is electrically connected to an electronic apparatus. As an example, the electronic apparatus is a mobile communication apparatus, e.g. a mobile phone, and the mobile communication apparatus includes the detecting system 10. The detecting system 10 includes a power supply 12, a detecting resistor 14, a thermic resistor 16, and a detecting circuit 18. The power supply 12 is used for generating a testing current. The detecting resistor 14 is connected to the power supply 12. The thermic resistor 16 is disposed in the battery 11 and connected to the detecting resistor 14. The detecting circuit 18 is connected to a node 15 between the detecting resistor 14 and the thermic resistor 16. The detecting circuit 18 is used for detecting a first voltage of the node 15 and for generating a detecting signal to determine whether the battery 11 is electrically connected to the electronic apparatus.

As an example, the detecting circuit 18 includes a comparator for comparing the first voltage with a reference voltage to generate the detecting signal. In another example, the detecting circuit 18 may be a software code running on a processor or control unit to compare the first voltage with the reference voltage. As an example of practice, when the first voltage is larger than or equal to the reference voltage, the detecting signal is a first detecting value for indicating that the battery is not electrically connected to the electronic apparatus. In another example of practice, when the variation of the first voltage is larger than or equal to the variation of the reference voltage during a specific span of time, the detecting signal is a first detecting value for indicating that the battery is not electrically connected to the electronic apparatus. In other words, by comparing a status of the first voltage with a status of a reference voltage, a detecting circuit determines whether the battery is electrically connected or disconnected with the electronic apparatus. The status can be the voltage value of the first voltage or the voltage variation of the first voltage. During practice, persons skilled in the art may configure corresponding parameters to make the thermic resistor to render the situation of the battery.

It's noticed that the detecting circuit should not be limited by the above-mentioned two embodiments. In other words, the detecting circuit of the invention can be other forms to compare the first voltage with the reference voltage. On the other hand, the detecting circuit can also detect whether the variation of the voltage during a span of time, instead of detecting the voltage at a specific time, is larger than or equal to the variation of a reference voltage to determine whether the battery is electrically connected to the electronic apparatus.

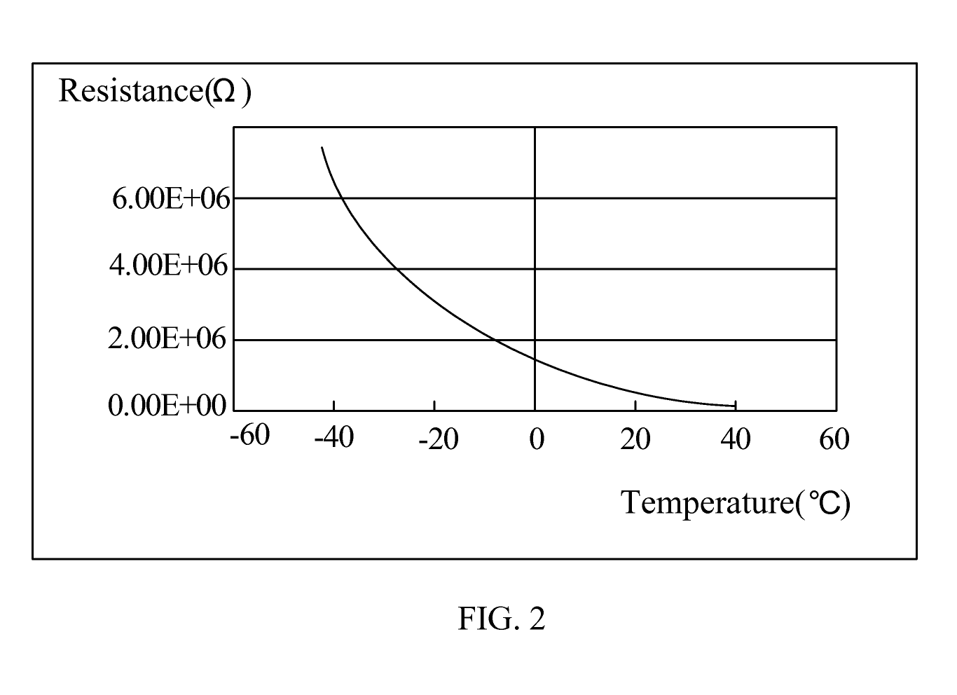

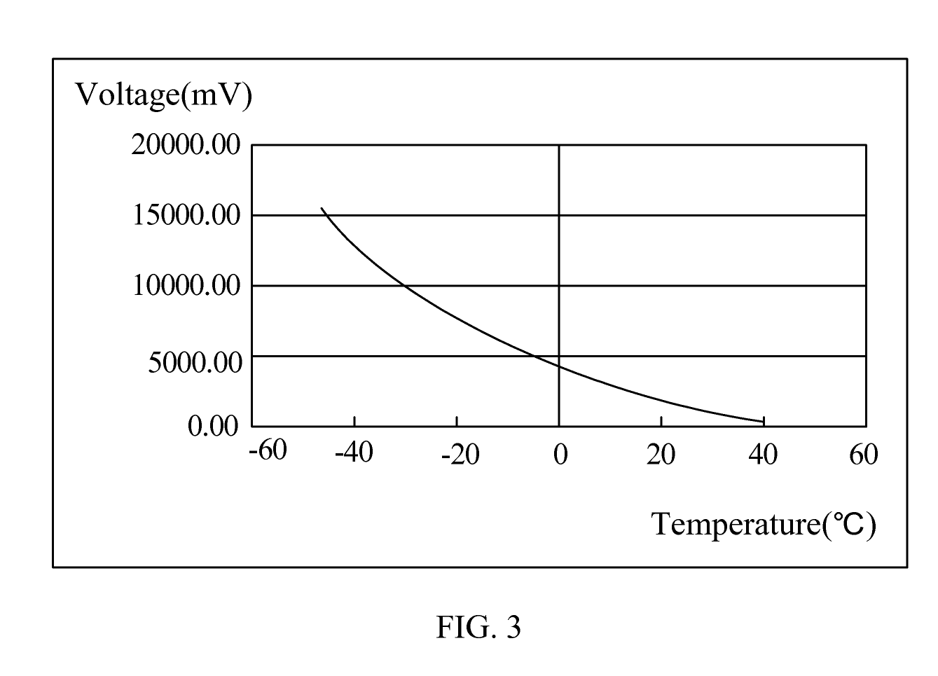

Referring to FIG. 2 and FIG. 3, FIG. 2 is a schematic diagram illustrating the relation between resistance of the thermic resistor and the temperature of the battery. FIG. 3 is a schematic diagram illustrating the relation between the voltage and the temperature. As shown in FIG. 2 and FIG. 3, because resistance of the thermic resistor of the battery varies with the temperature of the battery and the voltage between two ends of the thermic resistor will be influenced to change, accordingly, the detecting system can determine whether the battery is electrically connected to the electronic apparatus. For example, when the temperature of the battery decreases, resistance of the resistor of the thermic resistor increases, and then the voltage between two ends of the thermic resistor also increases. When the battery is not in the electronic apparatus or not electrically connected to the electronic apparatus well, the temperature of the battery decreases, and then the voltage increases. Thus, by detecting the voltage or the variation of the voltage, the resistor of the thermic resistor or the variation of the resistor can be obtained, and then the temperature of the battery can be obtained. Accordingly, the detecting system of the invention can determine whether the battery is in the electronic apparatus or the battery is not electrically connected with the electronic apparatus well.

For describing the invention in detail, when the battery is not in the electronic apparatus or the battery is not electrically connected with the electronic apparatus well, the temperature of the battery will decrease, and then the resistor of the thermic resistor will increase. Therefore, the voltage detected by the detecting circuit 18 also increases.

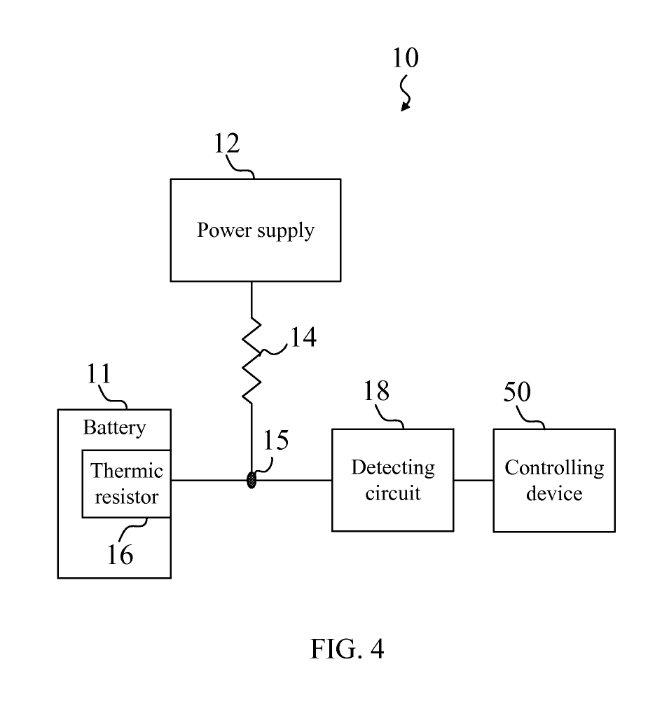

FIG. 4 is a schematic diagram illustrating the detecting system according to another preferred embodiment of the invention. The detecting system 10 further includes a controlling device 50 connected to the detecting circuit 18. The controlling device 50 switches off the electronic apparatus when the detecting signal is a first detecting value. Accordingly, it prevents the electronic apparatus from being charged when the battery is not electrically connected to the electronic apparatus well, so as to avoid damaging the electronic apparatus.

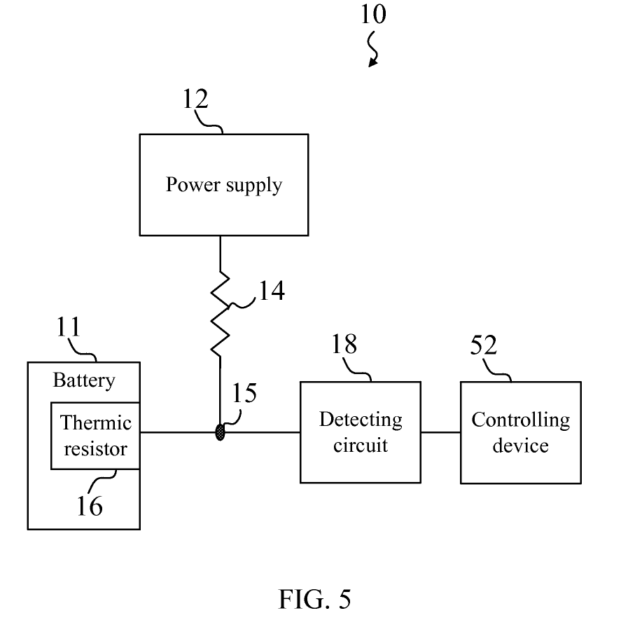

Referring to FIG. 5, FIG. 5 is a schematic diagram illustrating the detecting system according to another embodiment of the invention. In this embodiment, the detecting system 10 further includes a display device 52 connected to the detecting circuit 18. The display device 52 is used for displaying an error message when the detecting signal outputting by the detecting circuit 18 is the first detecting value.

In another embodiment, the electronic apparatus is a mobile phone. The mobile phone has a power supply to generate a testing current. A detecting resistor is connected to the thermic resistor of the battery in series. The detecting circuit detects the voltage of the node continually to obtain the variation between two ends of the thermic resistor. Then, the detecting system utilizes the relation between the voltage and the temperature shown in FIG. 3 to get the temperature of the battery. When the detected temperature of the battery is too low, the mobile phone will be switched off automatically or displays an error message on the screen, so as to prevent the mobile phone from being damaged due to improper charging.

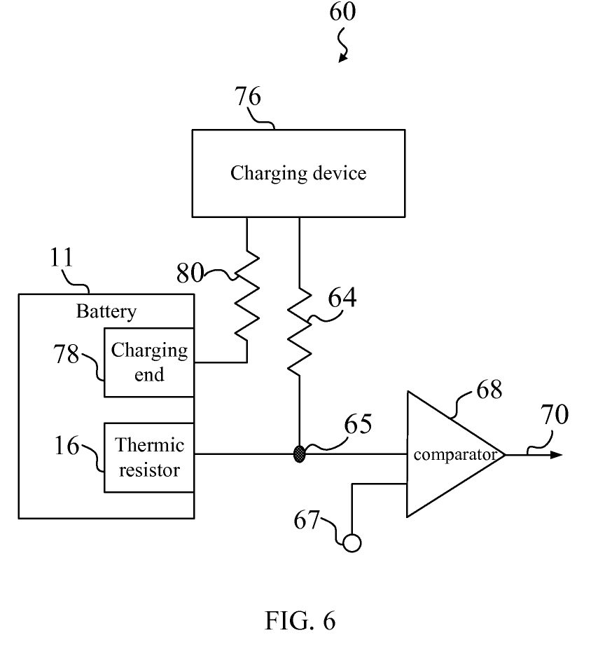

FIG. 6 is a schematic diagram illustrating the detecting system according to another embodiment of the invention. The detecting system can be applied in not only a mobile phone but also a common battery charger. As shown in FIG. 6, the detecting system 60 applied in a battery charger is used for detecting whether the battery 11 is electrically connected to the battery charger. The battery charger includes a charging device 76, connected to a charging end 78 of the battery 11, for charging the battery 11. A resistor 80 is connected between the charging device 76 and the charging end 78 and used for fixing the current from the charging device 76 to the charging end 78. The detecting resistor 64 is connected between the charging device 76 and the thermic resistor 16 of the battery 11. In this embodiment, the detecting circuit is a comparator 68. A testing current generated by the charging device 76 passes through the detecting resistor 64 and the thermic resistor 16. The comparator 68 compares the first voltage of the node 65 between the detecting resistor 64 and the thermic resistor 16 with a reference voltage 67 and then generates the detecting signal 70 according to the comparison. Then according to the detecting signal 70, the detecting system determines whether the battery 11 is electrically connected to the battery charger well. When the battery 11 is not electrically connected to the battery charger properly, the battery charger is switched off automatically to stop charging the battery 11.

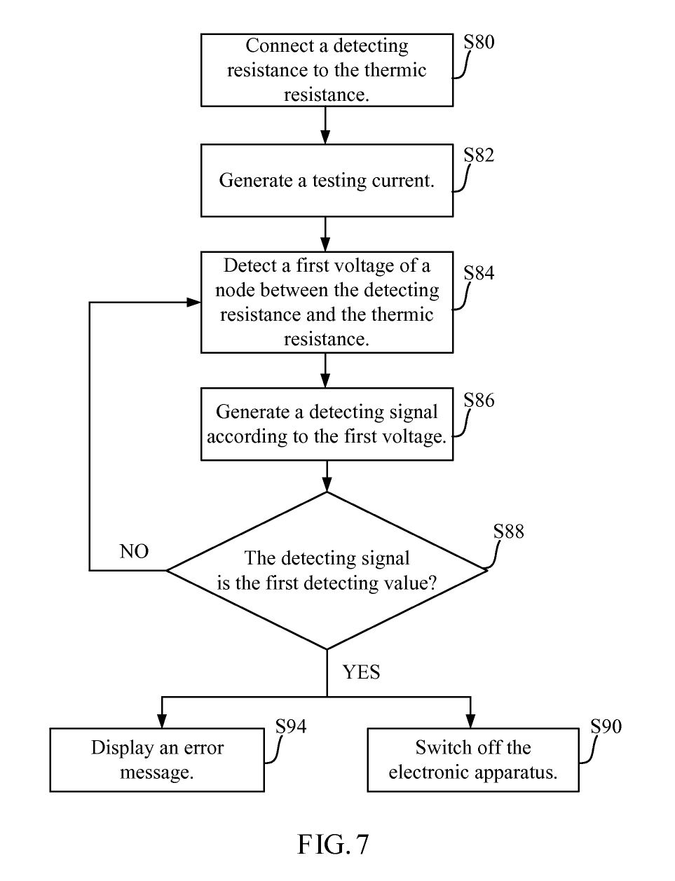

FIG. 7 is a flowchart illustrating the detecting method according to a preferred embodiment of the invention. The detecting method of the invention is used for detecting whether a battery is electrically connected to an electronic apparatus, wherein the battery has a thermic resistor. The detecting method includes the following steps. At start, step S80 is performed to connect a detecting resistor to the thermic resistor. Afterward, step S82 is performed. In step S82, a testing current is generated and then passes through the detecting resistor and the thermic resistor. Step S84 is then performed. In step S84, a first voltage of a node between the detecting resistor and the thermic resistor is detected. Step S86 is then performed. In step S86, according to the first voltage, a detecting signal is generated to determine whether the battery is electrically connected to the electronic apparatus well, wherein the detecting signal is generated by comparing the first voltage with a reference voltage.

In an embodiment, when the first voltage is larger than or equal to the reference voltage, the detecting signal is a first detecting value for indicating the battery is not electrically connected to the electronic apparatus. In another embodiment, when the variation of the first voltage is larger than or equal to the variation of the reference voltage during a specific span of time, the detecting signal is a first detecting value for indicating the battery is not electrically connected to the electronic apparatus.

In this embodiment, the detecting method further comprises the following steps. Step S88 is performed to determine whether the detecting signal is the first detecting value. Step S90 is then performed. In step S90, the electronic apparatus is switched off when the detecting signal is the first detecting value.

In another embodiment, when the detecting signal is determined as the first detecting value in step S88, step S94 is then performed. In step S94, an error message is displayed when the detecting signal is the first detecting value.

Because resistance of the thermic resistor of the battery varies with the temperature of the battery and the voltage between two ends of the thermic resistor is affected to change, once the battery is detached from the electronic apparatus or is not electrically connected to the electronic apparatus well, the temperature of the battery decrease accordingly. The detecting system can determine whether the battery is electrically connected to the electronic apparatus well by the voltage detected by the detecting circuit, so as to protect the electronic apparatus.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A detecting system in an electronic apparatus for detecting whether a battery is electrically connected to the electronic apparatus, the battery having a thermic resistor, the detecting system comprising:
a power supply generating a testing current;
a detecting resistor connected to the power supply and the thermic resistor; and
a detecting circuit, connected to a node between the detecting resistor and the thermic resistor, that detects variation of a first voltage of the node during a span of time, to determine whether the battery is electrically connected to the electronic apparatus.

2. The detecting system of claim 1, further comprising a controlling device connected to the detecting circuit, for switching off the electronic apparatus when determining the battery is not electrically connected to the electronic apparatus.

3. The detecting system of claim 1, further comprising a display device, connected to the detecting circuit, for displaying an error message when determining the battery is not electrically connected to the electronic apparatus.

4. The detecting system of claim 1, wherein the electronic apparatus is a mobile communication apparatus.

5. The detecting system of claim 1, wherein the electronic apparatus further comprises a charging device, connected to a charging end of the battery, for charging the battery.

6. The detecting system of claim 1, wherein the variation of the first voltage is generated by a response of the thermic resistor to a variation in a temperature of the battery.

7. The detecting system of claim 1, wherein the detecting circuit comprises a comparator that compares the first voltage with a predetermined reference voltage to generate the detecting signal.

8. The detecting system of claim 1, wherein the detecting circuit compares the first voltage with a predetermined voltage to generate a detecting signal, and when the first voltage is greater than or equal to the predetermined reference voltage, the detecting signal is a first detecting value indicating that the battery is electrically connected to the electronic apparatus.

9. A method for detecting whether a battery is electrically connected to an electronic apparatus, the battery having a thermic resistor, the method comprising:
connecting a detecting resistor to the thermic resistor;
generating a testing current passing through the detecting resistor and the thermic resistor;
detecting variation of a first voltage of a node between the detecting resistor and the thermic resistor during a span of time; and
according to the variation of the first voltage during the span of time, generating a detecting signal to indicate whether the battery is electrically connected to the electronic apparatus.

10. The detecting method of claim 9, wherein the detecting signal is generated by comparing the variation of the first voltage with variation of a reference voltage during the span of time.

11. The method of claim 10, wherein when the variation of the first voltage is greater than or equal to the variation of the reference voltage, the detecting signal is a first detecting value indicating that the battery is electrically connected to the electronic apparatus.

12. The detecting method of claim 10, wherein when the variation of the first voltage is larger than or equal to the variation of the reference voltage during the span of time, the detecting signal is a first detecting value for indicating the battery is not electrically connected to the electronic apparatus.

13. The detecting method of claim 12, further comprising the following steps:
determining whether the detecting signal is the first detecting value; and
switching off the electronic apparatus when the detecting signal is the first detecting value.

14. The detecting method of claim 12, further comprising the following steps:
determining whether the detecting signal is the first detecting value; and
displaying an error message when the detecting signal is the first detecting value.

15. The detecting method of claim 9, wherein the electronic apparatus is a mobile communication apparatus.

16. The detecting method of claim 9, wherein the electronic apparatus further comprises a charging device, connected to a charging end of the battery, for charging the battery.

17. The method of claim 9, wherein the variation of the first voltage comprises a response of the thermic resistor to a variation in a temperature of the battery.

18. The method of claim 9, further comprising comparing the first voltage with a predetermined reference voltage to generate the detecting signal.

19. A method for determining whether a battery is properly electrically connected to an electronic apparatus, comprising:
using a thermic resistor for outputting a first voltage in response to a temperature of the battery;
comparing a status of the first voltage with a reference voltage status for generating a comparison result, wherein the status of the first voltage is a variation of the first voltage; and
determining whether the battery is properly electrically connected to the electronic apparatus according to the comparison result.

20. The method of claim 19, further comprising detecting variation of the first voltage at a node between a detecting resistor and the thermic resistor, generating the first voltage from a response of the thermic resistor to a variation in a temperature of the battery during the span of time, and generating a detecting signal, wherein when the first voltage is greater than or equal to the predetermined reference voltage, the detecting signal is a first detecting value indicating that the battery is electrically connected to the electronic apparatus.
